(19) United States
(12) Patent Application Publication
(10) Pub. No.: US 2025/0300505 A1
(43) Pub. Date: Sep. 25, 2025

(54) MOTOR AND MOBILITY DEVICE INCLUDING THE SAME

(71) Applicants: HYUNDAI MOTOR COMPANY, Seoul (KR); KIA CORPORATION, Seoul (KR)

(72) Inventors: Hyung Kwan Jang, Uijeongbu-si (KR); Hoo Dam Lee, Seoul (KR); Kyung Sik Choi, Seoul (KR); Jun Hyeok Choi, Suwon-si (KR); Byung Ho Min, Suwon-si (KR); Tae Gyu Lee, Seoul (KR)

(73) Assignees: HYUNDAI MOTOR COMPANY, Seoul (KR); KIA CORPORATION, Seoul (KR)

(21) Appl. No.: 18/920,435

(22) Filed: Oct. 18, 2024

(30) Foreign Application Priority Data
Mar. 21, 2024 (KR) 10-2024-0039215

(51) Int. Cl. H02K 1/26; H02K 3/02; H02K 55/00

(52) U.S. Cl. CPC H02K 1/26; H02K 3/02; H02K 55/00; H02K 2213/03

(57) ABSTRACT

A motor includes a stator having a plurality of stator coils repeatedly disposed in a circumferential direction and a rotor configured to rotate around a rotating shaft, including a magnetic material generating rotational force by interacting with the plurality of stator coils. The magnetic material forms a band shape and is configured to be continuously disposed in the circumferential direction. The magnetic material is repeatedly arranged in the axial direction, forming a plurality of layers in the axial direction.

### CROSS-REFERENCE TO RELATED APPLICATIONS

This application claims priority to and the benefit of Korean Patent Application No. 10-2024-0039215, filed on Mar. 21, 2024 in the Korean Intellectual Property Office, the disclosure of which is incorporated herein by reference in its entirety.

### TECHNICAL FIELD

The present disclosure relates to a motor and a mobility device including the same.

### BACKGROUND

Generally, an electric motor may include a direct current (DC) motor or an alternating current (AC) motor depending on the power source used. An AC motor may include a synchronous motor and an induction motor, depending on the structure thereof. A synchronous motor may have high efficiency and may be easily controlled, but it may be difficult to manufacture a synchronous motor, and the price thereof may be relatively high. An induction motor may be widely used since an induction motor may have a simplified structure, may be highly resistant to external shocks, and may be inexpensive.

Recently, as research and development of electric vehicles has accelerated, the demand for electric motors has increased significantly. Usually, a high-speed, high-output electric motor has been used as a driving source for an electric vehicle.

A mobility device, including a hybrid electric vehicle, an air mobility vehicle, or the like, may be partially or completely driven by a motor rather than a general internal combustion engine. As a motor for the mobility devices, an interior permanent magnet synchronous motor (IPMSM) to which a permanent magnet is applied has been widely used. An IPMSM may have high efficiency and output. However, to reduce cost for rare earth materials used in a permanent magnet and the requirement for high efficiency and output, there has been increasing interest in a motor using other magnetic materials. In other words, a general motor may have limitations in increasing output, and it may be difficult to meet the requirements of gaining increasingly high-performance for a mobility device.

### SUMMARY

An aspect of the present disclosure provides a structure of a motor which may implement a high output by using different magnetic materials in a rotor and may be easily used.

The purpose of the present disclosure is not limited thereto, and a person having ordinary skill in the art should understand that other technical issues not mentioned herein could be derived from the configurations used in the specification and drawings.

According to an embodiment of the present disclosure, a motor may include a stator having a plurality of stator coils repeatedly disposed in a circumferential direction and a rotor configured to rotate around a rotating shaft. The rotor may include a magnetic material generating rotational force by interacting with the plurality of stator coils. The magnetic material may form a band shape and may be configured to be continuously disposed in the circumferential direction. The magnetic material may be repeatedly arranged in an axial direction, forming a plurality of layers in the axial direction.

The magnetic material may include a bonding portion for each layer of the plurality of layers in the axial direction, and the bonding portions provided on the magnetic material may be disposed at the same distance in the circumferential direction.

The magnetic material may include N number of bonding portions for each layer of the plurality of layers disposed in the axial direction, where N is a natural number of 2 or more. The bonding portions disposed in each layer may be disposed at the same distance in the circumferential direction.

The entirety of bonding portions provided on the magnetic material may be disposed at the same distance in the circumferential direction.

The plurality of stator coils may be provided to have L number of phases, where L is a natural number. The magnetic material may include at least one bonding portion for each layer of the plurality of layers disposed in the axial direction. A number of the bonding portions disposed in the magnetic material may be a multiple of L.

The bonding portions provided on the magnetic material may be disposed at the same distance in the circumferential direction.

A plurality of the magnetic materials may be stacked on one another in a radial direction, forming a plurality of layers in the radial direction.

The magnetic material may be configured as a superconducting wire.

The magnetic material may be a copper wire or an aluminum wire.

The motor may further include a rotor sleeve surrounding an exterior of the magnetic material.

The rotor sleeve may be formed of a non-magnetic material.

According to an embodiment of the present disclosure, a motor may include a stator having a plurality of stator coils repeatedly disposed in a circumferential direction and a rotor configured to rotate around a rotating shaft. The rotor may include a magnetic material generating rotational force by interacting with the plurality of stator coils. N number of pieces of the magnetic material may be configured to be continuously disposed in the circumferential direction, where N is a natural number of 2 or more.

The pieces forming the magnetic material each may have the same shape and the same size.

The magnetic material may include a bonding portion in a portion adjacent to each of the pieces. N number of the bonding portions may be provided, where N is a natural number of 2 or more. The bonding portions may be disposed at the same distance in the circumferential direction.

The plurality of stator coils may be provided to have L number of phases, where L is a natural number. N, the number of magnetic material pieces, may be a multiple of L.

The magnetic material may include a bonding portion in a portion adjacent to each of the pieces. N number of the bonding portions may be provided, where N is a natural number of 2 or more. The bonding portions may be disposed at the same distance in the circumferential direction.

The magnetic material may be at least one of a superconducting wire, a copper wire, or an aluminum wire.

The motor may further include a rotor sleeve surrounding an exterior of the magnetic material.

The rotor sleeve may be formed of a non-magnetic material.

According to an embodiment of the present disclosure, a mobility device may include at least one drive means provided on the body; a battery disposed in the body; and a motor connected to the battery and providing driving force to the at least one drive means.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective diagram illustrating a motor according to an embodiment of the present disclosure;

FIG. 2 is an exploded perspective diagram illustrating a motor according to an embodiment of the present disclosure;

FIG. 3 is an exploded perspective diagram illustrating a rotor and a diagram illustrating a position of a bonding portion according to an embodiment of the present disclosure;

FIG. 4 is an exploded perspective diagram illustrating a rotor and a diagram illustrating a position of a bonding portion according to another embodiment of the present disclosure;

FIGS. 5A and 5B are cross-sectional diagrams illustrating the rotor illustrated in FIGS. 3 and 4;

FIG. 6 is a diagram illustrating an example of magnetizing a rotor according to an embodiment of the present disclosure;

FIG. 7 is a perspective diagram illustrating a rotor according to an embodiment of the present disclosure;

FIG. 8 is an exploded perspective diagram illustrating the rotor illustrated in FIG. 7;

FIG. 9 is a perspective diagram illustrating a rotor according to another embodiment of the present disclosure;

FIG. 10 is an exploded perspective diagram illustrating rotor illustrated in FIG. 5; and

FIGS. 11, 12A and are perspective diagrams illustrating an example of a mobility device to which a motor is applied according to an embodiment of the present disclosure.

### DETAILED DESCRIPTION

Hereinafter, embodiments of the present disclosure are described with reference to the attached drawings. However, redundant descriptions and detailed descriptions of known functions and elements which may unnecessarily make the gist of the present disclosure obscure are not be provided. In the drawings, components having similar functions and application are indicated by same reference numerals.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right of the example embodiments.

The terms such as “part,” “portions,” or the like may be used to describe various components, but the components should not be limited to the terms. The above terms may refer to physically/visually distinct components, and also functions or configurations of the corresponding portion even when distinction/compartment is not clear.

The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

Unless otherwise indicated, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings as having unless clearly defined such in the present application.

In some embodiments, a mobility device may refer to a device or vehicle configured to move through spaces such as land, underground, air, space, sea, and/or underwater. In one embodiment, a mobility device on the ground or underground may be disposed in the form of, for example, a vehicle, a robot, or the like. In another embodiment, a mobility device in the air or space may relate to aerial mobility, and may be disposed in the form of, for example, a general fixed-wing or rotary-wing aircraft, an advanced air mobility (AAM) device which has been actively developed recently, a means of transportation mounted on an unmanned aerial vehicle, a drone, a rocket, and a satellite, or the like. In another embodiment, a mobility device at sea or underwater may be implemented as, for example, a ship, a submarine, or the like. The mobility device may not be limited to a specific space and may be implemented as a mobile body moving the above-mentioned spaces (i.e., a mobile body which may move between multiple spaces), and may be implemented as, for example, an amphibious vehicle, or a flying vehicle.

In the description below, the terms “front side,” “rear side,” “lateral side,” “front,” “back,” “upper and lower,” “above,” “below,” “lower portion,” “left and right,” and the like are defined with respect to a vehicle or a body of a vehicle. Also, the terms including ordinal number such as “first,” “second,” and so on may be used in the description and the claims to distinguish the elements from one another. These terms are used only for the purpose of differentiating one component from another, without limitation thereto.

Generally, a motor 100 may include a stator 110 and a rotor 130, and the rotor 130 may be configured to rotate by electromagnetic interaction between the stator 110 and the rotor 130. As described above, a motor 100 may include a permanent magnet synchronous motor (PMSM) in which a magnetic material 150 (i.e., permanent magnets, or the like) may be used in the rotor 130, and a wound field synchronous motor (WFSM) in which a field coil may be wound on the rotor 130.

Recently, a superconducting wire (or copper wire, aluminum wire, or the like) may be used as a magnetic material 150 of the rotor 130. However, since a superconducting wire has superconducting properties in a cryogenic environment, when a superconducting bulk/stacked superconducting wire is applied to a motor rotor 130, it may be necessary to magnetize the superconducting bulk/superconducting stacked wire at least once before driving the motor 100, such that rotor 130 magnetizing may need to be performed according to the position.

However, generally, magnetic materials 150 disposed in the rotor 130 may be repeatedly provided and spaced apart from each other at a predetermined distance in the rotation direction of the rotor 130 (i.e., a circumferential direction). To magnetize the materials, the magnetizing device 200, 201, 202, 203, 204 may need to align with a position of the magnetic material 150 and be magnetized. However, it may not be easy to accurately align the magnetic material 150 and the magnetizing device 200, 201, 202, 203, 204. Accordingly, the magnetic material 150 disposed in the circumferential direction may not be accurately magnetized, which may be problematic.

In other words, to magnetize a superconducting wire by applying the same as a magnetic material 150 of a motor rotor 130, it may be necessary to determine the exact position of the superconducting wire and to adjust the position to match the magnetizing position. To this end, another device may be necessary, and system components may increase.

In an embodiment, a magnetic material 150 (e.g., superconducting wire, copper wire, aluminum wire, or the like) applied to the rotor 130 may be provided continuously in the circumferential direction. By this structure, the magnetic material 150 of the rotor 130 may be continuously disposed in the circumferential direction, such that magnetizing may be performed smoothly without adjusting the rotor position during the magnetizing process. To implement such a structure, the magnetic material 150 of the rotor 130 may be disposed in the form of a continuous band in the circumferential direction and may be wound around the rotor 130, or a plurality of magnetic material pieces may be provided continuously in the circumferential direction.

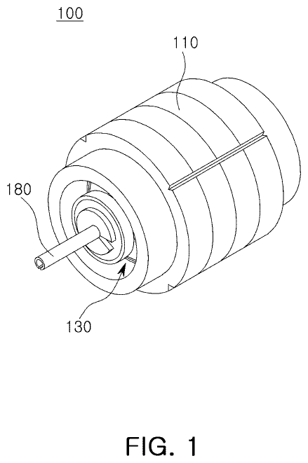

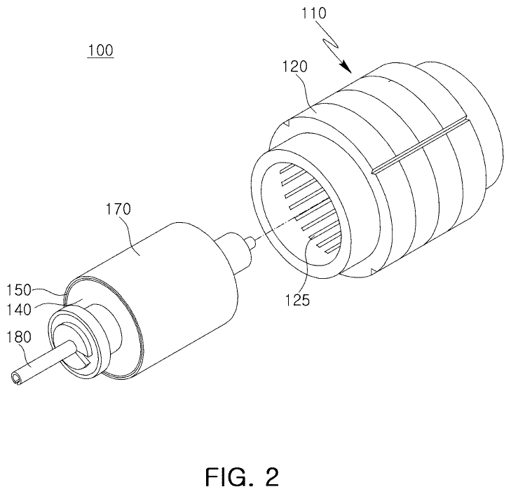

Referring to FIGS. 1 and 2, the motor 100 according to an embodiment may include a stator 110 and a rotor 130. The rotor 130 may be fixed to and installed on the rotating shaft 180, and the rotor 130 may rotate around the rotating shaft 180 together with the rotating shaft 180 in the stator 110.

Although not illustrated, a structure in which a stator 110 is disposed in a rotor 130 may also be included in an embodiment. For example, the stator 110 may be disposed in a cylindrical shape, the rotor 130 may be disposed in a cylindrical shape to surround an exterior of the stator 110, and the rotor 130 surrounding an exterior of the stator 110 may rotate around a rotating shaft 180.

In the description below, the direction in which the rotating shaft 180 extends may be defined as the axial direction, the direction perpendicular to the rotating shaft 180 may be defined as the radial direction, and the direction in which the rotor 130 rotates around the rotating shaft 180 may be defined as the circumferential direction.

In an embodiment, the motor 100 may include a stator coil 125 in the stator 110 and a magnetic material 150 generating rotational force by interacting with the stator coil 125 in the rotor 130. The magnetic material 150 may be configured as a superconducting wire, a copper wire, or an aluminum wire, or the like.

An air gap may be provided between the stator 110 and the rotor 130 to facilitate rotation of the rotor 130. Accordingly, a magnetic gap length may be formed between the stator 110 and the rotor 130.

In an embodiment, the motor 100 may include a stator 110 having a plurality of stator coils 125 repeatedly disposed in the circumferential direction, and a rotor 130 configured to rotate around a rotating shaft 180 on an internal side of the stator 110. The rotor 130 may include a magnetic material 150 interacting with the stator coil 125.

The stator 110 may include a stator body 120 having a cylindrical shape and a stator coil 125 repeatedly disposed in the circumferential direction on the internal side surface of the stator body 120. In an embodiment, the motor 100 may implement a motor 100 having various phases depending on the arrangement of the stator coil 125, such as a 3-phase, 4-phase, or 5-phase motor.

In one embodiment, the rotor 130 may include a rotor body 140 having a cylindrical shape, rotating around the rotating shaft 180 and provided on the internal side of the stator body 120. The rotor 130 may further include a magnetic material 150 provided on an external surface of the rotor body 140 and generating rotational force by interacting with the stator coil 125. The external surface of the magnetic material 150 may include a cylindrical rotor sleeve 170 fixed and coupled to the magnetic material 150 or the rotor body 140 to prevent the magnetic material 150 from being separated. The rotor sleeve 170 may be formed of a non-magnetic material (e.g., STS, CFRP, or the like).

The magnetic material 150 may be configured as a superconducting wire, a copper wire, or an aluminum wire, or the like. When the magnetic material 150 is a superconducting wire, the superconducting wire may use a MHOS structure or a stacked HTS wire structure in which superconducting wires are stacked.

The magnetic material 150 may be disposed in a band shape continuously in the circumferential direction. For example, the magnetic material 150 of the rotor 130 may be provided in the form of a continuous band in the circumferential direction and wound onto the rotor 130. In another embodiment, the band shaped magnetic material 150 may be repeatedly arranged along the axial direction, forming a plurality of layers 151, 153, and 155 in the axial direction. The magnetic material 150 may be disposed in a structure in which wires are repeatedly stacked in each layer (i.e., a plurality of layers 151, 153, and 155).

In an embodiment, the magnetic material 150 may have at least two layers in the axial direction. In the description of the embodiment, a structure including three layers 151, 153, and 155 in the axial direction is described as a representative example for ease of description.

The magnetic material 150 may include bonding portions 151a, 153a, and 155a for the layers 151, 153, and 155 disposed in the axial direction, respectively. The wire continuously disposed in the circumferential direction may be wound, and the bonding portions 151a, 153a, and 155a may be provided on an end to secure the wires.

The entirety of bonding portions 151a, 153a, and 155a disposed in the magnetic material 150 may be disposed at the same distance in the circumferential direction.

After the superconducting wires continuously disposed in the circumferential direction is wound, the bonding portions 151a, 153a, and 155a may be provided on an end to fix the wires. The magnetic material 150 of the superconducting wire may have magnetic flux at a wire end portion (i.e., bonding portion 151a, 153a, and 155a), such that the bonding portion 151a, 153a, and 155a in which the wire is connect may be disposed to have the same distance in the circumferential direction.

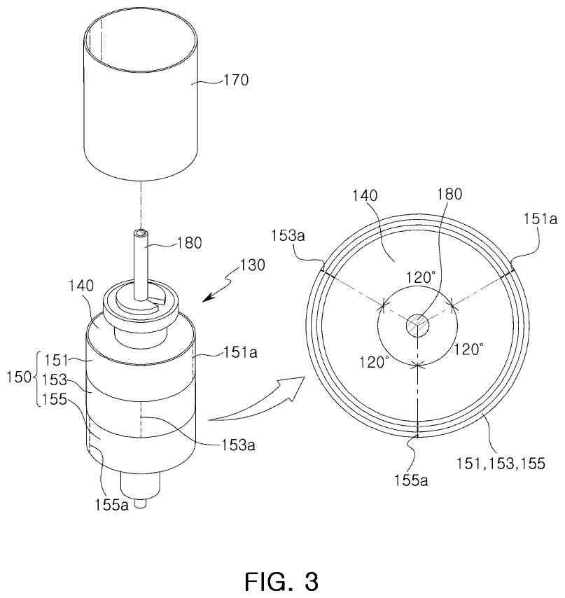

In other words, referring to FIG. 3, the layers 151, 153, and 155 may include the bonding portions 151a, 153a, and 155a, respectively. When the three magnetic materials 151, 153, and 155 having the stack structure as above are viewed on a plane, although the components are disposed in different positions in the axial direction, three bonding portions 151a, 153a, and 155a disposed in the circumferential direction may be disposed at the same distance in the circumferential direction. For example, the bonding portions 151a, 153a, and 155a may be disposed at a distance of 120 degrees (deg.) (=360/3 degrees) in the circumferential direction.

In an embodiment, the magnetic material 150 may include a plurality of layers. For example, considering the magnetic material 150 including N number of layers 151, 153, and 155 (where N is a natural number of 2 or more), the total number of bonding portions 151a, 153a, and 155a disposed in the layers may be N, and the bonding portions 151a, 153a, and 155a may be disposed at the same distance in the circumferential direction. For example, in this case, the distance between the bonding portions 151a, 153a, and 155a may be ‘360/N’ degrees in the circumferential direction.

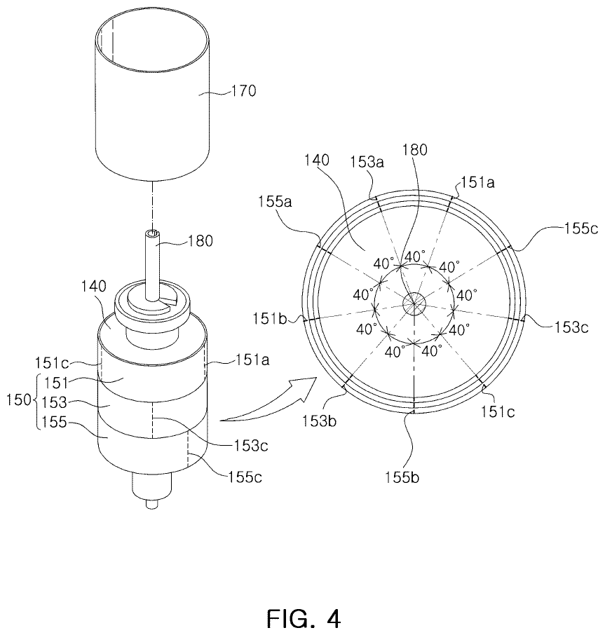

Also, referring to FIG. 4, in an embodiment, the magnetic material 150 may have a plurality of layers 151, 153, and 155 in the axial direction, and each layer disposed in the axial direction may include N number of bonding portions 151a, b, c, 153a, b, c, and 155a, b, c (where N is a natural number of 2 or more). In the description of the embodiment, for ease of description, the magnetic material 150 may include three layers 151, 153, and 155 in the axial direction, and each layer may include three bonding portions 151a, b, c, 153a, b, c, and 155a, b, c.

In an embodiment, in the magnetic material 150, the bonding portions 151a, b, c, 153a, b, c, and 155a, b, c disposed in the layers 151, 153, and 155 may have the same distance therebetween in the circumferential direction.

In an embodiment, the entirety of bonding portions 151a, b, c, 153a, b, c, and 155a, b, c disposed in the magnetic material 150 may be disposed at the same distance in the circumferential direction.

In other words, referring to FIG. 4, the layers 151, 153, and 155 may include three bonding portions 151a, b, c 153a, b, c, and 155a, b, c, respectively. When the three magnetic materials 151, 153, and 155 configured as above is viewed on a plane, even though the bonding portions 151a, b, c, 153a, b, c, and 155a, b, c are disposed in different positions in the axial direction, the nine bonding portions 151a, b, c, 153a, b, c, and 155a, b, c disposed in the circumferential direction may be disposed at the same distance in the circumferential direction. In other words, the bonding portions 151a, b, c, 153a, b, c, and 155a, b, c may be disposed at a distance of 40 degrees (=360/9 degrees) in the circumferential direction.

Also, as illustrated in FIG. 4, in an embodiment, the bonding portions 151a, b, c, 153a, b, c, and 155a, b, c disposed in the layers of the magnetic material 150 may be disposed with the same distance therebetween in the circumferential direction. Accordingly, the nine bonding portions 151a, b, c, 153a, b, c, and 155a, b, c disposed in the layers 151, 153, and 155 may be disposed alternately in the circumferential direction.

In an embodiment, the magnetic material 150 may include a plurality of layers 151, 153, and 155, for example, a magnetic material 150 including N number of layers 151, 153, and 155 (where N is a natural number of 2 or more), and considering the magnetic material 150 having M number of bonding portions 151a-151c, 153a-153c, 155a-155c (M is a natural number greater than or equal to 2), the total number of bonding portions (151a-151c, 153a-153c, 155a-155c) disposed in the layers 151, 153, and 155 may be N*M, and the bonding portions may be disposed at the same distance in the circumferential direction. For example, in this case, the distance between the bonding portions (151a-151c, 153a-153c, 155a-155c) may be ‘360/(N*M)’ degrees in the circumferential direction.

In an embodiment, the motor 100 may be implemented as an L-phase motor (where L is a natural number) having various phases depending on the arrangement of the stator coil 125, such as a 3-phase, 4-phase, or 5-phase motor. Accordingly, the stator coil 125 may be provided such that a coil wound in the circumferential direction may have an L-phase such as 3-phase, 4-phase, 5-phase, or the like (where L is a natural number). Even in this case, the bonding portions (151a-151c, 153a-153c, 155a-155c) disposed in the layers 151, 153, and 155 may be disposed at the same distance in the circumferential direction.

Accordingly, in an embodiment, a number of the bonding portions (151a-151c, 153a-153c, 155a-155c)) disposed in the magnetic material 150 may be a multiple of L (where L is a natural number) (i.e., a multiple of 3, a multiple of 4, or a multiple of 5). Specifically, in the case of a 3-phase motor, the number of the bonding portions disposed in the magnetic material 150 may be a multiple of 3, and in the case of a 4-phase motor, the number of bonding portions disposed in the magnetic material 150 may be a multiple of 4. In the case of a 5-phase motor, the number of bonding portions disposed in the magnetic material 150 may be a multiple of 5.

After the superconducting wire continuously disposed in the circumferential direction is wound, the bonding portions (151a-151c, 153a-153c, and 155a-155c) may be disposed on an end to fix the wire. The magnetic material 150 of the superconducting wire may have the properties in which magnetic flux is reduced at the wire end portion (i.e., bonding portion 151a, b, c, 153a, b, c, and 155a, b, c), the bonding portions (151a-151c, 153a-153c, 155a-155c) in which the wire is connected may have the same distance therebetween in the circumferential direction. Also, the arrangement of the bonding portions (151a-151c, 153a-153c, 155a-155c) may be disposed to be more optimized depending on the type of motor 100. For example, as described above, in the case of an L-phase motor (where L is a natural number), the number of the bonding portions may be a multiple of L, and the number of the bonding portions provided in 3-phase, 4-phase, or 5-phase motors may be a multiple of 3, a multiple of 4, or a multiple of 5.

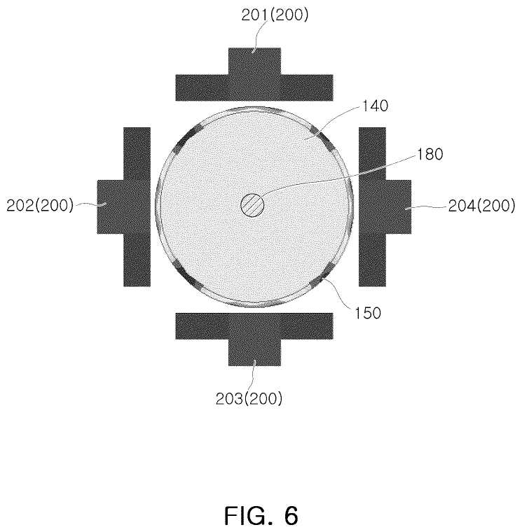

FIG. 6 illustrates an example in which the rotor magnetic material 150 disposed in the motor 100 is magnetized. As illustrated in FIG. 6, in an embodiment, since the rotor magnetic material 150 is continuously disposed in the circumferential direction, an aligning process separate from the magnetizing device 200, 201, 202, 203, 204 may not be necessary, and the rotor magnetic material 150 may be disposed in an appropriate magnetizing position. Magnetizing may be performed such that magnetizing may be performed in the correct position in the circumferential direction.

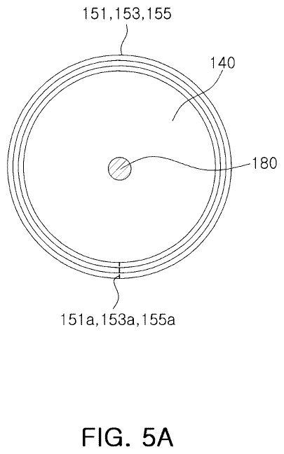

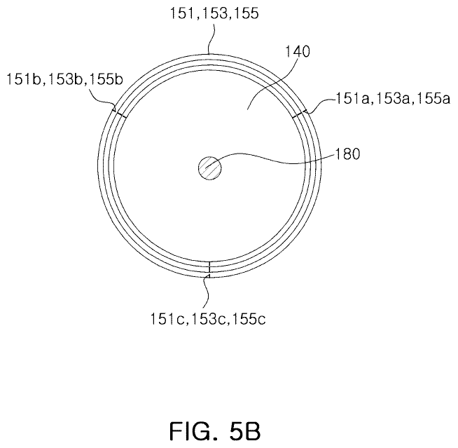

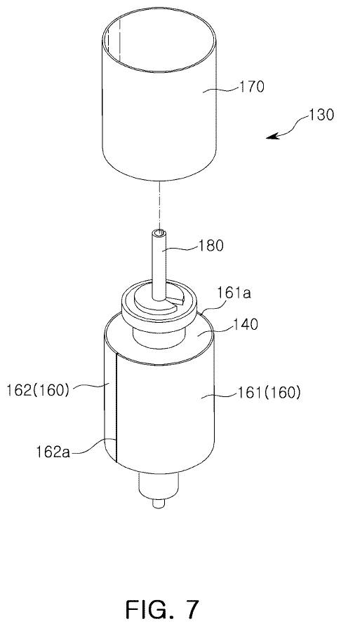

FIGS. 7 to 11B illustrate another embodiment of the rotor 130. The rotor 130 in another embodiment may be applied to the motor 100 described with reference to FIGS. 1 to 6, and only the coupling structure of the magnetic material 160 coupled to the rotor body 140 may be different. Accordingly, the same reference numeral may be used for the other components, detailed descriptions will not be repeated, and only the magnetic material 160, which is a different component, will be described using a different reference numeral.

In an embodiment, the magnetic material may be a 160 degree superconducting wire, copper wire, or aluminum wire, or the like. Also, when the magnetic material 160 is a superconducting wire, the superconducting wire may use a MHOS structure or a stacked HTS wire structure in which superconducting wires are stacked.

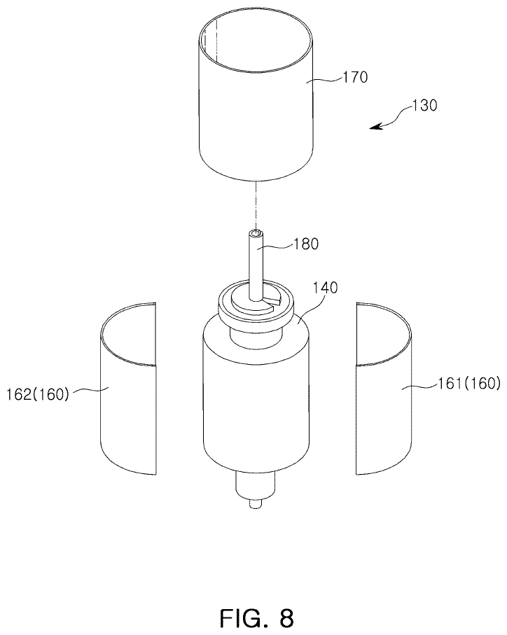

Referring to FIGS. 7 and 8, a plurality of pieces 161 and 162 of the magnetic material 160 may be disposed continuously in the circumferential direction. For example, the magnetic material 160 may be coupled to an external surface of the rotor body 140 such that a plurality of pieces 161 and 162 may be continuously disposed in the circumferential direction. By this structure, the magnetic material 160 may have the bonding portions 161a and 162a in the circumferential direction, but the bonding portions 161a and 162a may be disposed continuously without a distance therebetween.

The magnetic material 160 may be disposed in a structure in which wires are repeatedly stacked in each layer (i.e., a plurality of layers).

In an embodiment, the magnetic material 160 may have at least two different pieces 161 and 162 in the circumferential direction, and bonding portions 161a and 162a having a length in the axial direction may be provided between the pieces 161 and 162.

In the description of the embodiment, for ease of description, the structure of the magnetic material 160 having two pieces 161 and 162 in the circumferential direction is described as a representative example.

In an embodiment, the plurality of pieces 161 and 162 forming the magnetic material 160 may have the same shape and the same size. The bonding portions 161a and 162a may be disposed in connection portions of the magnetic material pieces 161 and 162 adjacent to each other in the circumferential direction.

The magnetic material pieces 161 and 162 may be continuously disposed in the circumferential direction, and the bonding portions 161a and 162a may be provided on ends on which the pieces 161 and 162 are adjacent to each other to fix the magnetic material pieces 161 and 162.

The entire bonding portions 161a and 162a disposed in the magnetic material 160 may be disposed at the same distance in the circumferential direction. Since the magnetic material pieces 161 and 162 have the same size, in order for the magnetic material pieces 161 and 162 to be continuously disposed in the circumferential direction, the length of the circumferential direction may be determined according to the number of magnetic material pieces 161 and 162. For example, when N number of magnetic material pieces 161 and 162 (where N is a natural number greater than or equal to 2) are disposed in the circumferential direction, the distance between the magnetic material pieces 161 and 162 in the circumferential direction may be determined to be ‘360/N’ degrees. Accordingly, the distance between the bonding portions 161a and 162a may also be determined to be ‘360/N’ degrees.

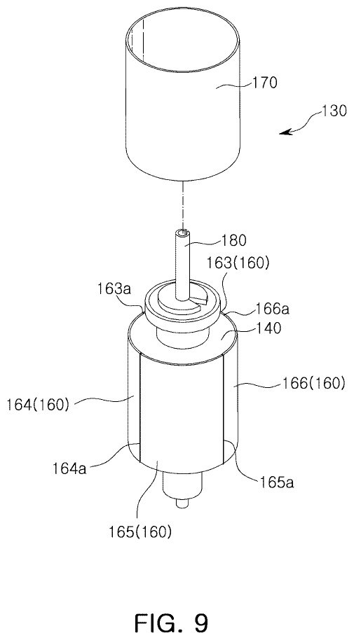

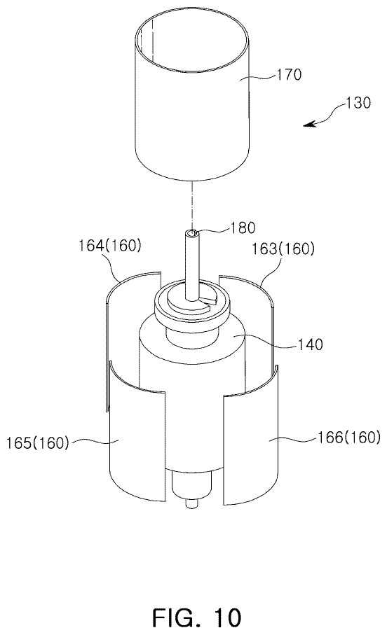

Referring to FIGS. 9 and 10, the magnetic material 160 may have four different pieces 163, 164, 165, and 166 in the circumferential direction, and bonding portions 163a, 164a, 165a, and 166a having a length in the axial direction may be disposed between the pieces 163, 164, 165, and 166. In an embodiment, four magnetic material pieces 163, 164, 165, and 166 may be provided, the magnetic material pieces 163, 164, 165, and 166 may have a 90 degree (360/4) distance in the circumferential direction. Accordingly, the bonding portions 163a, 164a, 165a, and 166a may also be disposed at a distance of 90 degrees (deg).

In an embodiment, the motor 100 may be implemented as an L-phase motor (where L is a natural number) having various phases depending on the arrangement of the stator coil 125, such as a 3-phase, 4-phase, or 5-phase motor. Accordingly, the stator coil 125 may be provided such that a coil wound in the circumferential direction may have an L-phase such as a 3-phase, 4-phase, 5-phase (where L is a natural number). Even in this case, the bonding portions 163a, 164a, 165a, and 166a disposed in the layers 163, 164, 165, and 166 may be disposed at the same distance in the circumferential direction.

Accordingly, in an embodiment, a number of bonding portions 163a, 164a, 165a, and 166a disposed in the magnetic material 160 may be a multiple of L (where L is a natural number) (i.e., a multiple of 3, a multiple of 4, or a multiple of 5). Specifically, in the case of a 3-phase motor, the number of bonding portions disposed in the magnetic material 160 may be a multiple of 3. In the case of a 4-phase motor, the number of the bonding portions disposed in the magnetic material 160 may be a multiple of 4. In the case of a 5-phase motor, the number of bonding portions disposed in the magnetic material 160 may be a multiple of 5.

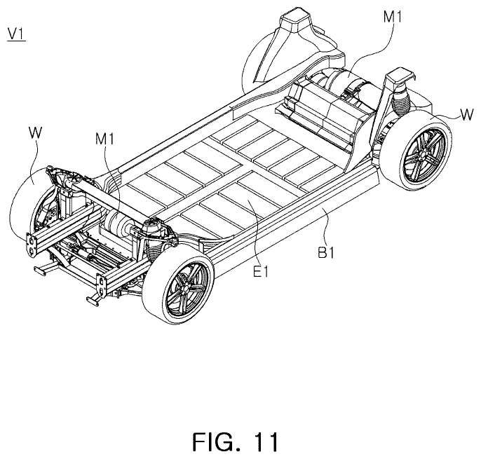

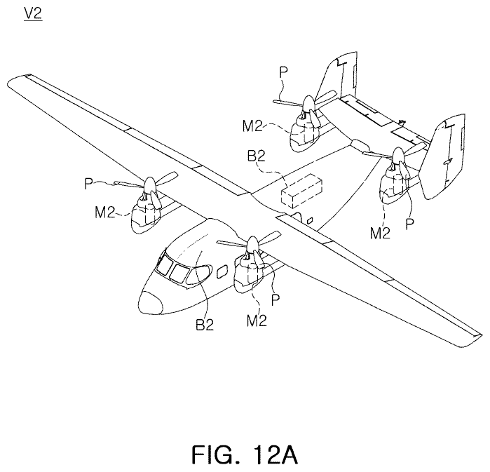

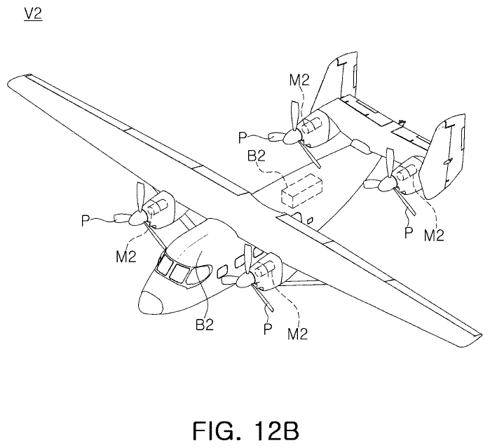

FIGS. 11 to 12B are perspective diagram illustrating an example of a mobility device V1 and V2 to which a motor M1 and M2 is applied according to an embodiment.

Mobility devices V1 and V2 according to an embodiment may include, at least, bodies B1 and B2, drive means W and P provided on the bodies B1 and B2, and batteries E1, E2 providing power to the motors M1, M2 in the embodiment linked to the drive means W and P. The motors M1 and M2 installed in the mobility devices V1 and V2 in the embodiment may be the motors 100 described with reference to FIGS. 1 to 10. Since the motor 100 may be installed as described with reference to FIGS. 1 to 10, a detailed description thereof will not be provided.

Referring to FIG. 11, the mobility device V1 in an embodiment may be configured as a vehicle V1 moving on the ground. The vehicle V1, which is a mobility device V1, may include at least the body B1, the wheel W as a drive means W provided on the body B1, the motor M1 linked to the drive means W, and a battery E1 providing power to the motor M1.

Also, referring to FIGS. 12A and 12B, the mobility device V2 in an embodiment may be configured as an aerial mobility device V2 moving in the air. The aerial mobility device V2 in the embodiment may include at least a fuselage B2, which is the body B2, a means of propulsion P (e.g., a propeller P), a drive means P disposed in the fuselage B2, the motor M2 linked to the propellant P, and a battery E2 providing power to the motor M2.

FIG. 12A illustrates a position of the propeller P when the aerial mobility device V2 takes off, lands, or hovers for turning at a specific point. FIG. 12B illustrates a position of the propeller P when the aerial mobility device V2 moves in position (i.e., travels). In other words, the direction in which the propeller P, the propellant P of the aerial mobility device V2, may be tilted. Accordingly, the motor M2 driving the propeller P may also be tilted.

In the case of the hovering mode illustrated in FIG. 12A, the wing and/or tail tilted propellant P may rotate to be substantially perpendicular to the fuselage B2. In the flight mode illustrated in FIG. 12B, the wing and/or non-tilted propellant P may rotate to be substantially parallel to the fuselage B2. The tilting of the wing and/or tail tilted propellant P may be synchronized depending on a flight mode. In the same flight mode, the tilting of each propellant P may be adjusted differently depending on attitude control and flight conditions.

Although not specifically illustrated, the mobility device V1 and V2 may move through spaces such as land, underground, air, space, sea, and/or underwater. A mobility device V1 on the ground or underground may be provided in the form of, for example, a vehicle, a robot, or the like. A mobility device V2 in the air or space may relate to aerial mobility, and may be provided in the form of, for example, a general fixed-wing or rotary-wing aircraft, an advanced air mobility (AAM) device which has been actively developed recently, a means of transportation mounted on an unmanned aerial vehicle, a drone, a rocket, a satellite, or the like. The mobility device V1 and V2 at sea or underwater may be implemented as, for example, a ship, a submarine, or the like. The mobility device V1 and V2 may not be limited to a specific space and may be implemented as a mobile body moving the above-mentioned spaces (i.e., a mobile body which may move between multiple spaces), and may be implemented as, for example, an amphibious vehicle, or a flying vehicle.

According to the aforementioned embodiments, the motor M1 and M2 for mobility device V1 and V2, which may generate high torque by changing the magnetic material 150 or 160 provided in the rotor 130 and facilitating the use thereof, may be provided.

The motor M1 and M2 may be implemented by simple structural modifications, and there may be no major modification compared to a general motor, but performance may be improved, such that the effect of substantially reducing costs may be obtained.

While the embodiments have been illustrated and described above, it should be apparent to a person having ordinary skill in the art that modifications and variations could be manufactured without departing from the scope of the present disclosure as defined by the appended claims.

What is claimed is:

1. A motor comprising:
a stator having a plurality of stator coils repeatedly disposed in a circumferential direction; and
a rotor configured to rotate around a rotating shaft, and including a magnetic material generating rotational force by interacting with the plurality of stator coils,
wherein the magnetic material forms a band shape and configured to be continuously disposed in the circumferential direction, and
wherein the magnetic material is repeatedly arranged in an axial direction, forming a plurality of layers in the axial direction.

2. The motor of claim 1,
wherein the magnetic material includes a bonding portion for each layer of the plurality of layers, and
wherein the bonding portions provided on the magnetic material are disposed at the same distance in the circumferential direction.

3. The motor of claim 1,
wherein the magnetic material includes N number of bonding portions for each layer of the plurality of layers, where N is a natural number of 2 or more, and
wherein the bonding portions disposed in each layer are disposed at the same distance in the circumferential direction.

4. The motor of claim 3, wherein the entirety of bonding portions provided on the magnetic material are disposed at the same distance in the circumferential direction.

5. The motor of claim 1,
wherein the plurality of stator coils are provided to have L number of phases, where L is a natural number,
wherein the magnetic material includes at least one bonding portion for each layer of the plurality of layers, and
wherein a number of the bonding portions disposed in the magnetic material is a multiple of L.

6. The motor of claim 5, wherein the bonding portions provided on the magnetic material are disposed at the same distance in the circumferential direction.

7. The motor of claim 1, wherein a plurality of the magnetic materials are stacked on one another in a radial direction, forming a plurality of layers in the radial direction.

8. The motor of claim 1, wherein the magnetic material is configured as a superconducting wire.

9. The motor of claim 1, wherein the magnetic material is a copper wire or an aluminum wire.

10. The motor of claim 1, further comprising:
a rotor sleeve covering an exterior of the magnetic material.

11. The motor of claim 10, wherein the rotor sleeve is formed of a non-magnetic material.

12. A motor comprising:
a stator having a plurality of stator coils repeatedly disposed in a circumferential direction; and
a rotor configured to rotate around a rotating shaft, and including a magnetic material generating rotational force by interacting with the plurality of stator coils,
wherein N number of pieces of the magnetic material are configured to be continuously disposed in the circumferential direction, where N is a natural number of 2 or more.

13. The motor of claim 12, wherein the pieces forming the magnetic material each have the same shape and the same size.

14. The motor of claim 12,
wherein the magnetic material includes a bonding portion in a portion adjacent to each of the pieces,
wherein N number of the bonding portions are provided, where N is a natural number of 2 or more, and
wherein the bonding portions are disposed at the same distance in the circumferential direction.

15. The motor of claim 12,
wherein the plurality of stator coils are provided to have L number of phases, where L is a natural number, and
wherein N, the number of magnetic material pieces, is a multiple of L.

16. The motor of claim 15,
wherein the magnetic material includes a bonding portion in a portion adjacent to each of the pieces,
wherein N number of the bonding portions are provided, where N is a natural number of 2 or more, and
wherein the bonding portions are disposed at the same distance in the circumferential direction.

17. The motor of claim 12, wherein the magnetic material is at least one of a superconducting wire, copper wire, or aluminum wire.

18. The motor of claim 12, further comprising:
a rotor sleeve covering an exterior of the magnetic material.

19. The motor of claim 18, wherein the rotor sleeve is formed of a non-magnetic material.

20. A mobility device comprising:
at least one drive means provided on a body of the mobility device;
a battery disposed in the body; and
a motor connected to the battery and providing driving force to the at least one drive means,
wherein the motor comprising:
a stator having a plurality of stator coils repeatedly disposed in a circumferential direction; and
a rotor configured to rotate around a rotating shaft and including a magnetic material generating rotational force by interacting with the plurality of stator coils,
wherein the magnetic material forms a band shape and configured to be continuously disposed in the circumferential direction, and
wherein the magnetic material is repeatedly arranged in an axial direction, forming a plurality of layers in the axial direction.
